(19) United States
(12) Patent Application Publication
(10) Pub. No.: US 2004/0001701 A1
(43) Pub. Date: Jan. 1, 2004

(54) Broadcast recording

(75) Inventor: Michael Roper, Hatton (GB)

Correspondence Address: MCGARRY BAIR PC, 171 MONROE AVENUE, N.W., SUITE 600, GRAND RAPIDS, MI, 49503, US

(73) Assignee: Sendo International Limited, Central (CN)

(21) Appl. No.: 10/249,908

(22) Filed: May 16, 2003

(30) Foreign Application Priority Data
May 17, 2002 (GB) GB 0211380.1

(51) Int. Cl. H04N 5/76; G06F 3/00; G06F 13/00

(52) U.S. Cl. 386/83; 725/53

(57) ABSTRACT

A method of recording a broadcast signal includes accessing a host server by an intermediary communication unit. The host server includes a database of broadcast program information. The method includes selecting one or more program(s) from the database, using said intermediary communication unit transmitting information relating to a selected program from the host server to the intermediary communication unit, where the programming information is extracted. At least one control signal is generated and transmitted from the intermediary communication unit to a broadcast signal recorder to set the recorder to record the selected broadcast program. As all the user is required to do is to select a required broadcast program, for example a broadcast television program, from a list, the likelihood of the user entering information or commands incorrectly is greatly reduced. Furthermore, the user does not necessarily need to obtain and enter any codes relating to such information.

### CROSS REFERENCE TO RELATED APPLICATIONS

This application claims priority of British Patent Application GB 0211380.1 filed May 17, 2002.

### BACKGROUND OF INVENTION

1. Field of the Invention

The present invention relates to a method of recording a video, audio or television broadcast program. The invention is applicable to, but not limited to, use of a wireless communication unit in a method of recording a television program broadcast or the like.

2. Description of the Related Art

In the field of this invention it is known that it is often desirable for a person to wish to record a broadcast program, such as a television program using a video recorder. A problem encountered is that, if the user is not able to operate the video recorder at the time of the broadcast, it is necessary for the user to pre-program the video recorder in order for it to commence recording and typically end recording at the correct times. Many users find this to be difficult, particularly if they do not have a user manual at hand. This can result in certain users not bothering to program their video recorder, or incorrectly programming their video recorder.

One known solution of overcoming this problem is Video+â [symbol] from Gemstarâ [symbol] . This system uses a code comprising a string of numbers that correspond to a specific television program that is broadcast. The code is generated by encoding the date, channel and television program (start and end) times of the broadcast. This code is then entered into a compatible video recorder, usually via a wireless communication link using a remote control. The video recorder decodes the code and uses the decoded broadcast information to set the video recorder to ultimately record the television program. This system provides the advantage that the process of programming the video recorder is significantly simplified, since all the user is required to do is to enter the correct code for the required program. Advantageously, the codes for television programs are provided in television listings available from newspapers, magazines and the like.

However, the inventor of the present invention has recognized that the Gemstar solution suffers from the problem that the user is still required to have a copy of a relevant television listing that provides the codes. Furthermore, it is then easy for the user to enter the code into the remote control incorrectly.

A still further problem is that, if the video recorder is not compatible with the Video+ system, it is necessary for a remote control that is compatible with the Video+ system to be configured with the code. The remote control operates on a timer and needs to be left in a position (i.e. in a line of site path to the video recorder to use infrared signaling) such that at the selected program time the remote control initiates operation of the video recorder in order to record the desired program.

A further improvement in recording television programs is provided by a system known as Program Delivery Control (PDC). PDC is a system that has been developed by broadcasters to identify television programs during transmission of the television program. Each television program is tagged by a unique code, which is transmitted by the broadcaster for the entire duration of the television program. This code is referred to as a PDC label, which comprises information including:

(i) The program channel;

(ii) The program date; and

(iii) The (original) program start time.

The PDC system allows the user to record the television program he or she desires. The user enters information about the desired television program, for example the Video+ code or the time, date and/or channel of the television program due to be broadcast. From this information, the video recorder calculates the likely PDC label for the television program. Just before the television program is broadcast, the broadcaster transmits the PDC label for that television program. The video recorder receives the broadcast PDC label and recognizes the label as corresponding to the television program that it is programmed to record. The video recorder then starts to record the television program. The PDC label is transmitted at thirty-second intervals by the broadcaster for the entire duration of the television program. When the video recorder detects that the PDC label is no longer being transmitted, it stops recording.

The PDC system provides the advantage of further simplifying the programming of a video recorder. However, the inventor of the present invention has recognized that the PDC system suffers from the problem that it requires the video recorder to be compatible with the PDC system. Furthermore, the user needs to manually enter details (e.g. the Video+ code or program information), which again, may be entered incorrectly. The PDC system also requires the broadcaster of the television program to transmit the PDC label, which adds to the complexity of the PDC approach.

Thus, a need has arisen for an improved broadcast transmission recording mechanism wherein the abovementioned disadvantages may be alleviated.

### SUMMARY OF INVENTION

In accordance with a first aspect of the present invention, there is provided a method of recording a broadcast signal, as claimed in claim 1.

In accordance with a second aspect of the present invention, there is provided a communication system, as claimed in claim 8.

In accordance with a third aspect of the present invention, there is provided a broadcast recorder, as claimed in claim 9.

In accordance with a fourth aspect of the present invention, there is provided a cellular communication unit, as claimed in claim 10.

In accordance with a fifth aspect of the present invention, there is provided a cellular communication unit, as claimed in claim 11.

In accordance with a sixth aspect of the present invention, there is provided a remote control device, as claimed in claim 13.

Further aspects of the present invention are as defined in the dependent Claims.

In summary, a method of recording broadcast signals, such as video, audio or television signals, is described. An intermediary communication unit, for example a cellular communication unit, a remote control or a combination thereof, accesses a remote host server to obtain video, audio or television programming information. The programming information is retrieved from a database 135 in the host server and forwarded to the intermediary communication unit where it is processed and used to generate one or more control signals for programming a video, audio or television recorder.

In this manner, a user of the intermediary communication unit is able to select the desired broadcast (television) program(s) from a list of programs and program the recorder with a greatly reduced likelihood that the user will enter recording information or commands incorrectly. Furthermore, the user does not necessarily require any prior knowledge of the date/day, time or channel on which the desired program is to be broadcast, but is able to access the information remotely.

### BRIEF DESCRIPTION OF DRAWINGS

Exemplary embodiments of the present invention will now be described, by way of example only, with reference to the accompanying drawings, in which:

FIG. 1 illustrates a video programming system 100 in accordance with a preferred embodiment of the present invention;

FIG. 2 illustrates an alternative embodiment of the present invention, whereby a transceiver forms an integral part of a remote control device, wireless communication unit or combination thereof;

FIG. 3 illustrates a block diagram of a wireless communication unit, adapted to support the inventive concepts of the preferred embodiments of the present invention; and

FIG. 4 illustrates a preferred process for implementing the inventive concepts of the present invention.

### DETAILED DESCRIPTION

The present invention provides an improved method of recording a broadcast program, in particular to program a video cassette recorder, or similar device such as a digital video recorder to record a broadcast television program. A remote control device, capable of connecting to a host server, is used to program the video recorder to record a desired television program. A user accesses the host server and, for example, selects from a television program listing, the television program that is to be recorded. The information for that television program is then uploaded to the remote control device, perhaps via a wireless communication unit, where the information includes an indication of the time, date, channel, etc. on which the television program is to be broadcast.

For the purposes of the foregoing description, the expression “broadcast” is used to encompass not only video, audio or television broadcasts, but also other broadcast signals such as software upgrades, multimedia files, whether transmitted over the Internet, over the air, or otherwise.

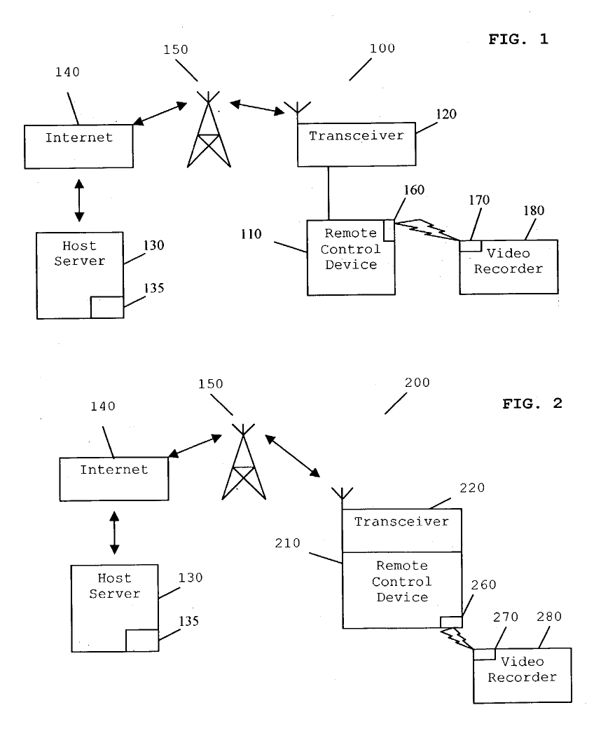

Referring now to FIG. 1, a video programming system 100 is illustrated in accordance with the preferred embodiment of the present invention. A remote control device 110 is connected to a transceiver 120. The transceiver is preferably a GSM transceiver for at least receiving data signals from a host server 130. For the illustrated embodiment, the host server 130 is connected to, or forms a part of, the Internet 140. The transceiver 120 receives data signals from the host server 130 via the Internet 140 and a wireless communications network, which for the illustrated embodiment is a Global System for Mobile Communication (GSM) network 150. The invention is equally applicable to a general packet radio system (GPRS) wireless communication system or a 3^{rd} generation (3G) cellular communication system.

Although it is preferable for the communications network to be a wireless communications network, it is within the contemplation of the present invention for the communications network to be a public switched telephone network (PSTN) or other form of data communications network.

The remote control device 110 comprises a transmission component 160, which in use transmits control signals to a receiver 170 of a video recorder 180. The control signals emitted from the remote control device 110 control at least some operational aspects of the video recorder 180.

It is within the contemplation of the invention that the term video recorder refers to any type of recording device capable of recording audio and/or video broadcast transmissions, such as television and/or radio programs or the like. Known devices include, by way of example only, video cassette recorders (VCR), digital video recorders, audio recorders, such as audio tape recorders, minidisk recorders, MP3 players, etc.

The host server 130 has stored thereon information relating to audio and/or video broadcast transmissions. For simplicity, television programs will be referred to as a combination of audio and video signals. However, such references are only exemplary, and can be substituted for any other form of broadcast transmission.

The television program information stored on the host server 130 may include, for each television program, by way of example only, one or more of the following:

(i) The date and/or day on which the television program is to be broadcast;

(ii) The time at which the television program is to be broadcast; and

(iii) The frequency and/or channel or other transmission information on which the television program is to be broadcast.

A user of the remote control device 110 is able to access the information stored on the host server 130 utilizing the GSM transceiver 120. The user may then select a television program to be broadcast that the user wishes to record using the video recorder 180. Upon selection of the required television program, the information relating to that television program stored on the host server 130 is transmitted, by way of a data signal to the GSM transceiver 120, via the Internet 140 and GSM network 150. The television program information is extracted from the data signal by the GSM transceiver 120. The GSM transceiver 120 is connected to, or otherwise in communication with, the remote control device 110, such that the television program information can be provided to the remote control device 110.

Such a connection between the GSM transceiver 120 and the remote control device 110 may be of any known form, such as by infrared (e.g. IrDA), wireless (e.g. Bluetooth), a Universal Serial Bus (USB), an RS232 serial interface, or any other suitable connection.

On receipt of the television program information, the remote control device 110 determines the appropriate control signals to send to the video recorder 180, in order for the video recorder 180 to record the selected television broadcast. The remote control device 110 then sends these control signals, via its transmission component 160, to the receiver 170 of the video recorder 180.

In this manner, a user who wishes to record a television program need only have access to the host server 130, for example using a GSM phone 120, to obtain television program listing(s) and details. The user is then able to program his/her video recorder to record the desired television program(s) via the remote control device 110.

Referring now to FIG. 2, an alternative embodiment of the present invention is illustrated, whereby the transceiver 220, for example a GSM-based transceiver, forms an integral part of the remote control device 210, i.e. the remote control device is capable of accessing the host server 130.

Again, the alternative embodiment of the present invention differs from the prior art methods described above in that the user may simply select the desired program from a program list. Preferably the desired information is transmitted to the remote control device 210 without the need for the user to enter complicated numeric strings, or commands.

The remote control device 210 includes a processor to extract the program information from the signal received from the host server. The remote control device 210 then uses this information to generate the appropriate control signals to program the video recorder 280. Alternatively, the remote control device 210 may, in conjunction with a timing mechanism (not shown) contained in the remote control device 210, be configured to program the video recorder 280 to record the program at the time of its broadcasting.

In a yet further alternative embodiment, it is envisaged that the GSM transceiver 220 may be configured to perform an additional communication feature, namely to perform the functionality of the remote control device 210. In this context, a user's mobile phone will provide a dual-mode operation: a first mode for normal audio/video communication, in particular for accessing the host server containing the television program listings; and a second mode for operation as a video (or audio) recorder's remote control 210.

It is within the contemplation of the invention that the video recorder 280 may be configured for control via, for instance, a GSM modem, in order for its operation to be controlled by the GSM transceiver. Alternatively, the GSM transceiver 220 may be configured to transmit at two independent frequencies a first frequency within the GSM frequency band and a second at a suitable remote control frequency.

With regard to any of the above embodiments, the video recorder 180, 280 may be programmed for recording a particular television channel from a first (starting) to a second (stopping) defined time period, based on control signals determined by the remote control device 110. The control signals may be transmitted from the remote control device 110, 210, via the transmission component 260 of the remote control device 110, 210 or the transmitter chain of the GSM transceiver 220, immediately upon determination of the appropriate control signals to be sent by the remote control device 110, 210.

Alternatively, upon determination of the control signals, the remote control device 110, 210 may inform the user that the control signals have been determined. The remote control device 110, 210 then only sends the control signals upon initiation by the user, for example by the user pressing an appropriate key, or utilizing another input element.

Alternatively, where the remote control device 110 comprises its own timing source, it may transmit appropriate control signals to the video recorder 180 just prior to the corresponding television program being broadcast. The timing for such control signals is based on the determined television program information. In this case, the control signals sent to the video recorder need not comprise information relating to the time of the broadcast, and may only be required to instruct the video recorder to tune to the appropriate channel/frequency and to start/stop recording whatever program is currently being broadcast on that channel.

The inventive concepts of the present invention are not considered as being limited to a wireless communication unit 110, 210 accessing the host server 130 via a wireless communication network 150 such as a GSM network and the Internet 140. Any alternative means of accessing the host server 130 may by used, for example via a public switched telephone network (PSTN), which may provide communication directly to the host server 130, or alternatively may provide communication with the Internet 140, or other computer network, which is linked to the host server 130.

In the described embodiments, the user has access to the host server 130 on which the database 135 containing the broadcast information is located. However it is within the scope of the present invention for the user to access a server separate to the host server 130 on which the database 135 is located. The server accessed by the user provides a user interface, and is connected to, in any known way, the host server of the database.

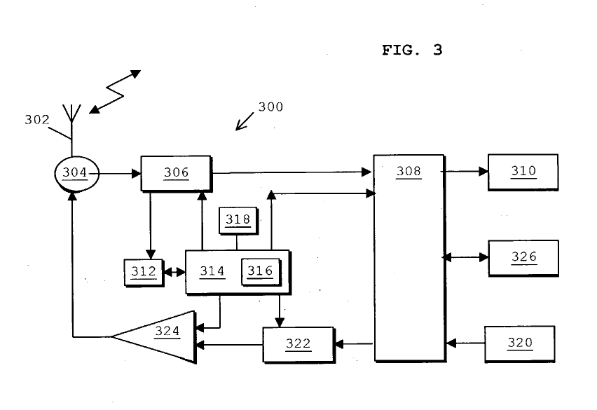

Referring now to FIG. 3, there is shown a block diagram of part of a wireless communication unit 300 adapted to support the inventive concepts of the preferred embodiments of the present invention. The communication unit 300, in the context of the preferred embodiment of the invention, is a mobile phone adapted for accessing the GSM network 150 of FIG. 1. The communication unit 300 transmits and receives data signals, including audio data (e.g. voice) signals, short message service (SMS) signals, etc, over the GSM network. As such, the communication unit 300 contains an antenna 302 preferably coupled to a duplex filter, antenna switch or circulator 304 that provides isolation between receive and transmit chains within the communication unit 300.

The receiver chain, as known in the art, includes scanning receiver front-end circuitry 306 (effectively providing reception, filtering and intermediate or base-band frequency conversion). The scanning front-end circuit is serially coupled to a signal processing function 308. An output from the signal processing function 308 is provided to a suitable output device 310, such as a screen or flat panel display.

The receiver chain also includes received signal strength indicator (RSSI) circuitry 312, which in turn is coupled to a controller 314 for maintaining overall communication unit control. The controller 314 is also coupled to the scanning receiver front-end circuitry 306 and the signal processing function 308 (generally realized by a digital signal processor (DSP)).

The controller 314 may therefore receive bit error rate (BER) or frame error rate (FER) data from recovered information. The controller is also coupled to a memory device 316 that stores operating regimes, such as decoding/encoding functions and the like.

A timer 318 is typically coupled to the controller 314 to control the timing of operations (transmission or reception of time-dependent signals) within the communication unit 300.

As regards the transmit chain, this essentially includes an input device 320, such as a keypad, coupled in series through transmitter/modulation circuitry 322 and a power amplifier 324 to the antenna 302. The transmitter/modulation circuitry 322 and the power amplifier 324 are operationally responsive to the controller.

In accordance with the preferred embodiment of the present invention, an external interface 326 is operably coupled to the signal processing function 326. The external interface may be of any suitable type, for example infrared (e.g. IrDA), RF (e.g. Bluetooth), a universal serial bus (USB) port, RS232 serial interface etc. In relation to the present invention, the external interface 326 allows the communication unit 300 to communicate with, and in particular send/pass broadcast program information to, a remote control device.

Of course, the various components within the communication unit 300 can be realized in discrete or integrated component form. Furthermore, it is envisaged that in alternative embodiments, the communication unit 300 may be a portable or mobile radio, a personal digital assistant, a laptop computer or a wirelessly networked PC that requires access to a communication system.

In a preferred embodiment of the present invention, the communication unit 300 is capable of accessing Internet sites, for example World Wide Web (WEB) sites, Wireless Application Protocol (WAP) sites, or sites compatible with NTT Docomo's i-modeâ [symbol] platform. The technology by which such devices are able to access these sites is well known, and so will not be discussed in detail here. However, for clarity purposes, a brief description of the process is described below.

In accordance with the preferred embodiment of the present invention, the communication unit 300 establishes a connection with a gateway server (not shown) via the GSM network 150 in order to access an Internet site. In order to access a particular Internet site or WEB/WAP page, the communication unit 300 sends a Universal Resource Locator (URL) of the required Internet site to the gateway server. The gateway server then sends a request for the content of the site or page that was indicated in the URL. A host server of the required Internet site or page receives the request, and sends the requested content back to the gateway server, where it is forwarded to the communication unit 300. It is also possible for the communication unit 300 to send data, for example a request, to a particular Internet site or page. Subsequently, the host server of the Internet site or page may send information to the communication unit 300. In each case, communication is performed via the gateway server.

As mentioned above, the host server 130 of FIG. 1 has stored thereon information relating to television program broadcasts or the like. Preferably, the host server 130 comprises a database 135 of television programs to be broadcast, which can be accessed via the Internet 140. For example, a person accessing the database 135 is able to view all programs to be broadcast over a use-selectable time period. In this manner, the user preferably accesses the database 135 via the input device, and views a list of television programs available over a selected time period on a one or more television channels.

Alternatively the user may be able to view television programs in alphabetical order. This may be more convenient when the person does not know when, and/or on which channel, the television program they are interested in is to be broadcast. In this way, the person is able to easily locate within the database 135 the television program of interest to them.

The user of the communication unit 300 is preferably able to access the database 135 stored on the host server 130, and locate the television program of interest to them. This access is preferably by way of a database 135 user interface provided by a WEB and/or WAP site located on the host server 130. Having located the desired television program, the user selects, or otherwise indicates to the host server 130 that this is the desired television program. The host server 130 then retrieves the information relating to that television program, which may or may not also be viewed by the user, and transmits it to the communication device 300, via the Internet 140 and GSM network 150 shown in FIG. 1. The communication unit 300 extracts the television program information from the data signals received from the host server 130, and preferably stores the information in an area of the memory device 316. Alternatively, the communication unit 300 may, for example, transmit video recording commands immediately to the video recorder.

The processor 308 then uses the television program information to determine the appropriate control signals to be transmitted to the video recorder, in a remote control device mode, in order for the video recorder to record the desired television program broadcast.

In accordance with the alternative embodiment of the present invention, it is envisaged that the communication unit 300 provides both the functionality of the remote control device 210 and the transceiver 220, as an integral part of the remote control device 210. In this alternative embodiment, the remote control device 210 is capable of accessing the program-listing database 135 on the remote host server 130. The remote control device 210 is configured to extract program information from a signal received from the host server 130, and generate control signals to program the recorder 180. In this regard, it is envisaged that such a dual-mode remote control device 210 has substantially the same operational elements as communication unit 300.

The remote control device 210 determines the required control signals to be sent to the video recorder, and transmits them to the video recorder as described above. In this regard, processor 308 in conjunction with controller 314 and timer 318 determines the signals to be sent to the video recorder.

In accordance with the yet further alternative embodiment of the present invention, the communication unit 300 (when viewed as say a dual-mode GSM unit) has been adapted to additionally perform a video remote control function. In this regard, the processor 308 has been adapted to transmit remote control signals in a second mode of operation. It is envisaged that, in this embodiment, the other elements of the transmitter chain may be adapted to enable a second (remote control) frequency, distinct from the GSM frequency band, to be supported.

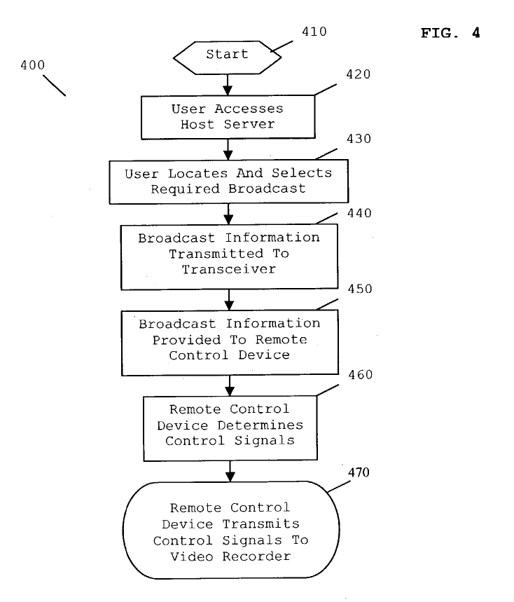

Referring now to FIG. 4, a flow chart 400 illustrates a preferred process for implementing the inventive concepts of the present invention. The process commences at step 410, for example when the user decides that he or she wants to record a particular broadcast.

Next, the user accesses the host server 130 in step 420. As previously described, this may require the user to initiate a WEB or WAP connection with the communication unit 300, and request a WEB or WAP page of a WEB/WAP site located on the host server 130.

Having accessed the host server 130, the user then locates and selects the required broadcast, in step 430, from a list or selection of broadcasts. For example, the WEB/WAP site may provide a user interface to the user, allowing the user to view broadcasts scheduled during periods specified by the user and/or on channels/frequencies specified by the user. Alternatively, it is envisaged that the user may be able to view broadcasts in alphabetical order.

When the user selects the desired program information, corresponding information is broadcast to the user, as shown in step 440. Such broadcast information may include: the day, start time, end time (or duration) and channel/frequency of the selected program. This information may be encoded and/or compressed and included as part of a data signal appropriate for the method of transmission. For example, where the user has accessed the host server 130 via the Internet 140, the data signal may be in the form of a Hyper Text Markup Language (HTML) message, or other appropriate message format used with the Internet 140, such as a Wireless Markup Language (WML) etc. Where the user has additionally/alternatively accessed the host server 130 over a mobile communication network 150 such as a GSM network, the information may be included as part of an appropriate data signal, such as a Short Message Service (SMS) message, Extended Short Message Service (EMS) message or Multimedia Messaging Service (MMS) message.

On receipt of the broadcast information by the transceiver, which in this example is the communication unit 300, the information is extracted from the data signal received from the host server 130. The program information is then provided to the remote control device in step 450. It will be appreciated that where the transceiver forms an integral part of the remote control device, as illustrated in FIG. 2, this step of the process is performed internally within the remote control device (or GSM communication unit).

In accordance with the preferred embodiment of the present invention, the remote control device determines the appropriate control signals to be sent to the video recorder, as in step 460. The remote control device then transmits the control signals to the video recorder, as shown in step 470. This may be performed as soon as the remote control device determines the appropriate control signals. Alternatively the user may perform this on initiation, or where the remote control device comprises a timing mechanism, just prior to the commencement of the broadcast.

Where the transceiver is separate to the remote control device in the preferred embodiment of the present invention, the remote control device preferably comprises a user input element, such as a keypad, touch screen display or any other form of user input. In this manner, the remote control device is capable of performing tasks normally associated with remote control devices, such as controlling one or more of the following video recorder operations:

(i) Play an audio/video recording stored on a recording media within, or connected to, the video recorder;

(ii) Stop playing the audio/video recording;

(iii) Pause the playing of the audio/video recording;

(iv) Commence recording a broadcast;

(v) Stop recording the broadcast;

(vi) Move forward and/or back within a recorded broadcast (i.e. fast forward and/or rewind); and

(vii) Change the channel/frequency on which to record/view a broadcast.

Where the transceiver forms an integral part of the remote control device, preferably the remote control device further comprises an output element such as an LCD display. The LCD display displays information to the user enabling him/her to access the host server, and locate/select the desired broadcast therefrom.

It will be understood that the video, audio or television broadcast recording mechanism, as described above, provides at least the following advantages:

(i) Since all the user is required to do is select the required program from a list or the like, the likelihood of the user entering information or commands incorrectly is greatly reduced.

(ii) The user does not necessarily require any prior knowledge of the date/day, time or channel on which the desired program is to be broadcast.

(iii) The user does not necessarily need to obtain and enter any codes relating to such information.

(iv) As the communication unit is an Internet-accessible unit that facilitates the recording operation, the user is capable of accessing the host server 130 at any convenient time. The information can then be stored in memory, and provided to the remote control device when convenient. The remote control device may then transmit the information to the recorder to record the desired program. Alternatively, the control information may be transmitted direct from the communication unit to the recorder.

Whilst the specific and preferred implementations of the embodiments of the present invention are described above, it is clear that one skilled in the art could readily apply variations and modifications of such inventive concepts.

Thus, a communication device and method for recording a broadcast have been described where the aforementioned disadvantages with prior art arrangements have been substantially alleviated.

1. A method of recording a broadcast signal, the method comprising the steps of:
accessing a host server by an intermediary communication unit, wherein the host server includes a database of broadcast program information;
selecting one or more program(s) from the database using said intermediary communication unit;
transmitting information relating to said selected one or more program(s) from the host server to said intermediary communication unit;
extracting programming information from the transmitted information at the intermediary communication unit; and
transmitting at least one control signal from the intermediary communication unit to a recorder to set the recorder to record the selected one or more broadcast program(s).

2. The method of recording a broadcast signal according to claim 1, wherein the broadcast signal refers to a broadcast video, audio or television signal, the method further comprising the step of:
transmitting program information from said intermediary communication unit to a remote control device, which transmits said at least one control signal to a video, audio or television recorder.

3. The method of recording a broadcast signal according to claim 2, wherein the step of extracting programming information is performed by the remote control device.

4. The method of recording a broadcast signal according to claim 1, wherein the step of accessing the host server includes the steps of:
initiating a WEB or WAP connection by the intermediary communication unit, and
requesting a WEB or WAP page of a WEB/WAP site located on the host server.

5. The method of recording a broadcast signal according to claim 4, wherein said step of transmitting information relating to said selected one or more program(s) includes:
(i) transmitting said information as a Hyper Text Markup Language (HTML) message or a compact HTML message; or
(ii) transmitting said information as a Wireless Markup Language (WML), where the user has accessed the host server via the Internet; or
(iii) transmitting said information as a Short Message Service (SMS) message where the user has accessed the host server via a mobile communication network; or
(iv) transmitting said information as an i-mode message.

6. The method of recording a broadcast signal according to claim 1, wherein the step of selecting one or more program(s), includes the step of allowing the user to view broadcast program information in one or more of the following ways:
(i) Programs scheduled during particular time periods, for example as specified by the user;
(ii) Programs on particular channels or frequencies, for example as specified by the user, or
(iii) Program information displayed in alphabetical order.

7. The method of recording a broadcast signal according to claim 1, wherein said broadcast program information includes one or more of the following: day, date, start time, end time, duration, channel, frequency of the selected one or more program(s).

8. A communication system, for example a wireless GSM communication system, adapted to facilitate the method steps of claim 1.

9. A broadcast signal recorder, for example a video cassette recorder or digital video recorder, adapted to receive at least one control signal from an intermediary communication unit such that said at least one control signal is arranged to program said broadcast signal recorder to record a selected broadcast program, wherein said at least one control signal operates at a wireless cellular frequency, for example a GSM frequency.

10. A cellular communication unit adapted to transmit remote control signals to a broadcast signal recorder, for example to set a video, audio or television recorder to record a broadcast video, audio or television program, according to the method of claim 1.

11. A cellular communication unit comprising:
a processor; and
a transmitter, operably coupled to the processor, wherein in a first mode of operation of said transmitter is configured to:
transmit cellular communication signals;
and in a second mode of operation:
said transmitter transmits remote control signals to a broadcast signal recorder, for example to program said recorder to record a broadcast video, audio or television program.

12. The cellular communication unit according to claim 11, wherein said processor, in cooperation with said transmitter, is arranged to access a remote host server to obtain broadcast program information stored thereon, the communication unit further comprising:
a receiver, operably coupled to said transmitter and said processor, configured to receive and process broadcast signal program information from said host server, such that said processor extracts and generates at least one control signal to transmit to said broadcast signal recorder in the second mode of operation.

13. A remote control device for use with a broadcast signal recorder, the remote control device comprising:
a communication link capable of connecting to a host server, wherein the host server includes a database of broadcast program information;
a user interface, operably coupled to the communication link, for displaying one or more programs from the database for a remote control user to select therefrom;
wherein said communication link enables said user to receive information relating to said selected one or more program(s) from the host server;
the remote control device further characterized by:
a processor extracting said information relating to said selected one or more program(s) and generating at least one control signal;
wherein said communication link transmits the at least one control signal to a broadcast signal recorder to record a broadcast signal program.

14. The remote control device according to claim 13, wherein said communication link includes a mechanism for transmitting or receiving information as a Hyper Text Markup Language (HTML) message; as a Wireless Markup Language (WML); or as a Short Message Service (SMS) message.
